(19) United States
(12) Patent Application Publication
(10) Pub. No.: US 2026/0217261 A1
(43) Pub. Date: Jul. 30, 2026

(54) IN-VEHICLE DEVICE AND SERVER DEVICE

(71) Applicants: TOYOTA JIDOSHA KABUSHIKI KAISHA, Toyota-shi (JP); DENSO TEN Limited, Kobe (JP)

(72) Inventors: Zhenqin SHI, Tokyo (JP); Akira TOYOTA, Kobe (JP); Ryosuke MATSUOKA, Kobe (JP); Koichiro TAKEUCHI, Nagoya-shi (JP)

(73) Assignees: TOYOTA JIDOSHA KABUSHIKI KAISHA, Toyota-shi (JP); DENSO TEN Limited, Kobe (JP)

(21) Appl. No.: 19/435,919

(22) Filed: Dec. 30, 2025

(30) Foreign Application Priority Data
Jan. 24, 2025 (JP) 2025-010942

(51) Int. Cl. B60W 50/00; H04W 4/44

(52) U.S. Cl. CPC B60W 50/00; H04W 4/44; B60W 2050/0083; B60W 2540/215; B60W 2556/45

(57) ABSTRACT

An in-vehicle device for performing setting of operations of a vehicle includes a communication unit that communicates with a server device, an input unit that accepts an operation of a user, and a control unit that transitions the in-vehicle device from a standby state to a running state in which a first setting is performed by an operation by the user, in response to a startup instruction, and after transitioning to the running state, does not perform a second setting by an instruction from the server device.

### CROSS-REFERENCE TO RELATED APPLICATION

This application claims priority to Japanese Patent Application No. 2025-010942 filed on January 24, 2025. The disclosure of the above-identified application, including the specification, drawings, and claims, is incorporated by reference herein in its entirety.

### BACKGROUND

### 1. Technical Field

The present disclosure relates to an in-vehicle device and a server device.

### 2. Description of Related Art

There is known technology for circumventing control conflict caused by a plurality of instructions given to a vehicle overlapping. For example, Japanese Patent No. 6837508 discloses technology for circumventing control conflict based on communicable distance in a communication standard when a vehicle and a terminal device communicate with each other.

### SUMMARY

There is room for improvement in accuracy of settings regarding vehicle operations.

In view of the above circumstances, an object of the present disclosure is to provide an in-vehicle device or the like that can improve accuracy of settings for vehicle operations.

An in-vehicle device according to an embodiment of the present disclosure is an in-vehicle device for performing setting of operations of a vehicle, including a communication unit that communicates with a server device, an input unit that accepts an operation of a user, and a control unit that transitions the in-vehicle device from a standby state to a running state in which a first setting is performed by an operation by the user, in response to a startup instruction, and after transitioning to the running state, does not perform a second setting by an instruction from the server device.

A server device according to an embodiment of the present disclosure includes a communication unit that communicates with an in-vehicle device that performs setting of operations of a vehicle, and a control unit that sends an instruction to the in-vehicle device to perform the setting when the in-vehicle device is in a standby state, in which, upon receiving a notification from the in-vehicle device indicating that the in-vehicle device transitioned to a running state, the control unit cancels sending the instruction to the in-vehicle device.

According to an embodiment of the present disclosure, accuracy of settings for vehicle operation can be improved.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a schematic configuration of a control system;

FIG. 2A is a sequence diagram showing operations of the control system; and

FIG. 2B is a sequence diagram showing operations of the control system.

### DETAILED DESCRIPTION OF EMBODIMENTS

An embodiment of the present disclosure will be described below.

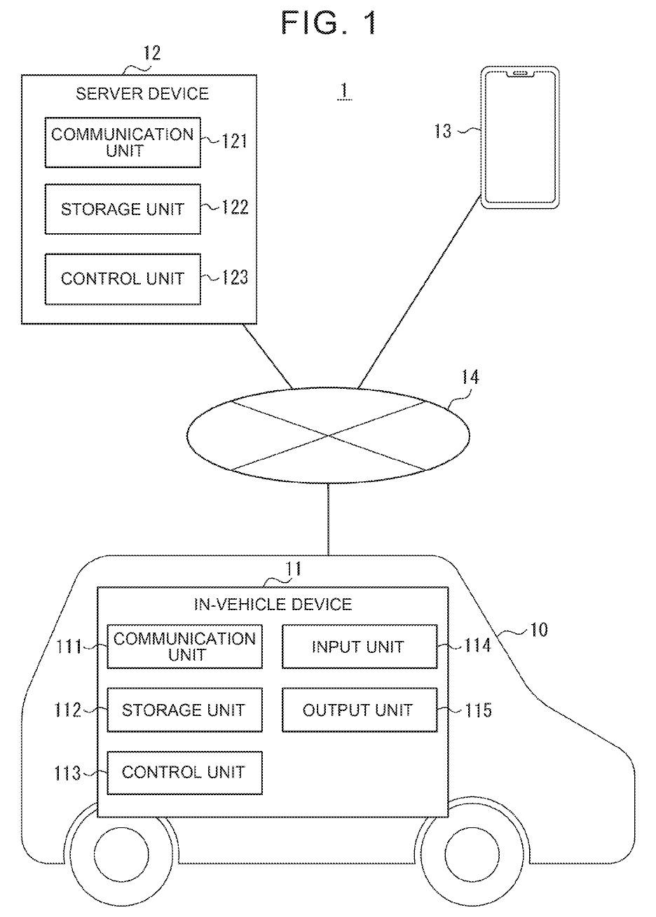

An overview of a control system 1 according to the embodiment of the present disclosure will be described with reference to FIG. 1. The control system 1 includes an in-vehicle device 11 installed in a vehicle 10, a server device 12, and a terminal device 13. The vehicle 10 is, for example, a passenger automobile, a commercial vehicle, or the like. The in-vehicle device 11 is an information processing device that controls the vehicle, such as an electronic control unit (ECU) or the like. The server device 12 is, for example, a server computer belonging to a cloud computing system or some other computing system and functioning as a server implemented with various functions. The server device 12 is, for example, a server provided by a business that operates the control system 1. The terminal device 13 is, for example, a personal computer or a tablet terminal device, and is used by the user of the vehicle 10. A network 14 is, for example, the Internet or a wide area network. The in-vehicle device 11 and the server device 12 are connected to each other via the network 14, so as to be able to communicate with each other. Also, the server device 12 and the terminal device 13 are connected to each other via the network 14, so as to be capable of communication with each other. The number of the vehicles 10, the in-vehicle devices 11, the server devices 12, and the terminal devices 13, illustrated in FIG. 1 may be determined optionally.

The in-vehicle device 11 according to the present embodiment performs settings for operation of the vehicle 10. In the following, setting operations includes modifying existing settings. Operations to be set in the vehicle 10 include overall operations of each of units making up the vehicle 10, such as operations of, for example, a drive recorder device, an automotive navigation system, a driver-assistance system, an air conditioning, and so forth. The in-vehicle device 11 includes a communication unit 111 that communicates with the server device 12 and an input unit 114 that accepts user operations. In response to a startup instruction, a control unit 113 of the in-vehicle device 11 transitions the in-vehicle device 11 from a standby state to a running state in which settings are performed by user operations (hereinafter referred to as "direct settings", for sake of convenience). After transitioning to the running state, settings in accordance with instructions from the server device 12 (hereinafter referred to as "remote settings", for sake of convenience) are not performed by the control unit 113. When a user who has been granted authority to perform settings operates the terminal device 13 via an app or the like, the remote settings are sent from the terminal device 13 to the server device 12 in accordance with the operations.

The server device 12 according to the present embodiment also includes a communication unit 121 that communicates with the in-vehicle device 11. A control unit 123 of the server device 12 sends an instruction to the in-vehicle device 11 to perform settings (hereinafter referred to as "remote settings instruction", for sake of convenience) when the in-vehicle device 11 is in the standby state. Upon receiving a notification from the in-vehicle device 11 indicating that the in-vehicle device 11 has transitioned to the running state, the control unit 123 cancels sending of the remote settings instruction to the in-vehicle device 11. Settings for the drive recorder include setting sensitivity of an impact detection function to one of three levels, for example, "high", "medium", or "low", and performing startup or stopping a continuous recording function and an audio recording function of a camera. Note that in the following description, when the user operates the terminal device 13 to issue an instruction from the terminal device 13 to the in-vehicle device 11 via the server device 12, this will be referred to as "via the server device 12".

The standby state of the in-vehicle device 11 is a state before startup, which is a state for the in-vehicle device 11 to accept a startup instruction. The startup instruction includes a startup operation by the user and a startup signal via the server device 12. The running state is a state in which various types of operations of the vehicle 10 are controlled after startup. Transition between the standby state and the running state is performed, for example, in response to the user sending a startup or stop instruction or the like to the in-vehicle device 11, either directly or via the server device 12 by operating the terminal device 13.

When the in-vehicle device 11 has a plurality of ECUs, the transition between the standby state and the running state is performed in stages. The ECUs include, for example, an ECU that performs detection of the vicinity of the vehicle 10 using a camera function, a collision detection function, and so forth, of the drive recorder (hereinafter referred to as "detection ECU"), and an ECU that sets operations of the vehicle 10 (hereinafter referred to as "control ECU"). In this case, when the vehicle 10 is stopped and the in-vehicle device 11 transitions to monitoring operations, the detection ECU is in the running state for monitoring surroundings of the vehicle 10, while the control ECU transitions to the standby state. During the monitoring operations, the control ECU transitions from the standby state to the running state upon receiving a startup instruction, or upon receiving a startup instruction from the detection ECU that has detected an abnormality. In the running state, the control ECU starts control of the operations of the vehicle 10, including analyzing information obtained from the detection ECU, emitting alarms, and so forth.

According to the present embodiment, a certain amount of time is required for the in-vehicle device 11 to receive the remote settings of settings via the server device 12, and although conflict in the setting contents may occur between the remote settings and the direct settings that are performed with respect to the in-vehicle device 11, such conflict can be circumvented. Accordingly, accuracy of the settings for the vehicle operation is improved with respect to the point that conflict between the settings instructed by the two systems is circumvented.

As illustrated in FIG. 1, the in-vehicle device 11 includes a storage unit 112 and an output unit 115, in addition to the communication unit 111, the control unit 113, and the input unit 114.

The communication unit 111 includes a mobile communication module compatible with mobile communication standards such as Long-Term Evolution (LTE), 4th Generation (4G), 5th Generation (5G), or the like, and a communication module compatible with wireless LAN standards. In the present embodiment, the communication unit 111 connects to the network 14 and communicates with the server device 12.

The storage unit 112 includes one or more memory devices. The memory devices may be, for example, semiconductor memory, magnetic memory, optical memory, or the like. Each of the memory devices included in the storage unit 112 functions as, for example, a main storage device, an auxiliary storage device, or cache memory. The storage unit 112 stores information to be used for operations of the in-vehicle device 11, and information obtained by the operations of the in-vehicle device 11. In the present embodiment, the storage unit 112 may store settings for operations of the vehicle 10 and application programs for performing settings of the operations of the vehicle 10.

The control unit 113 includes one or more processors, one or more programmable circuits, one or more dedicated circuits, or a combination thereof. The processor is, for example, a general-purpose processor such as a central processing unit (CPU), a graphics processing unit (GPU), or the like, or a dedicated processor specialized for specific processing. The programmable circuit is, for example, a field-programmable gate array (FPGA). The dedicated circuit is, for example, an application-specific integrated circuit (ASIC). The control unit 113 controls each of the units of the in-vehicle device 11 and also controls the overall operations of the in-vehicle device 11. In the present embodiment, the control unit 113 performs, for example, settings of the operations of the vehicle 10.

The input unit 114 includes one or more input devices that accept operations by an operator or a user. The input device is, for example, physical keys, capacitive keys, a capacitive panel, a touchscreen that is integrated with a display, a microphone that accepts speech input, or the like. The input unit 114 accepts input of information used in the operations of the control unit 113, and sends the information that is input to the control unit 113. In the present embodiment, the input unit 114 accepts, for example, a startup or stop operation and an operation for performing settings of the operations of the vehicle 10.

The output unit 115 includes one or more output devices that output information. The output device is, for example, a display that outputs information as video, or a speaker or the like that outputs information as audio. The output unit 115 outputs the information that is obtained through operations of the control unit 113. In the present embodiment, the output unit 115 outputs, for example, images or audio related to the settings of the operation of the vehicle 10.

As illustrated in FIG. 1, the server device 12 includes a storage unit 122 in addition to the communication unit 121 and the control unit 123.

The communication unit 121 includes one or more communication modules that connect to the network 14. The communication modules are compatible with, for example, a mobile communication standard, a wired LAN (local area network) standard, or a wireless LAN standard. In the present embodiment, the communication unit 121 is connected to the network 14, and communicates with the in-vehicle device 11 and the terminal device 13.

The storage unit 122 has the same configuration as the storage unit 112 of the in-vehicle device 11. The storage unit 122 stores information used for operations of the server device 12 and information obtained through operations of the server device 12. In the present embodiment, the storage unit 122 stores, for example, the running state and so forth of the in-vehicle device 11.

The control unit 123 has the same configuration as the control unit 113 of the in-vehicle device 11. The control unit 123 controls each of the units of the server device 12 and also controls the operations of the entire server device 12. In the present embodiment, the control unit 123 determines whether the in-vehicle device 11 is in the standby state or the running state, for example.

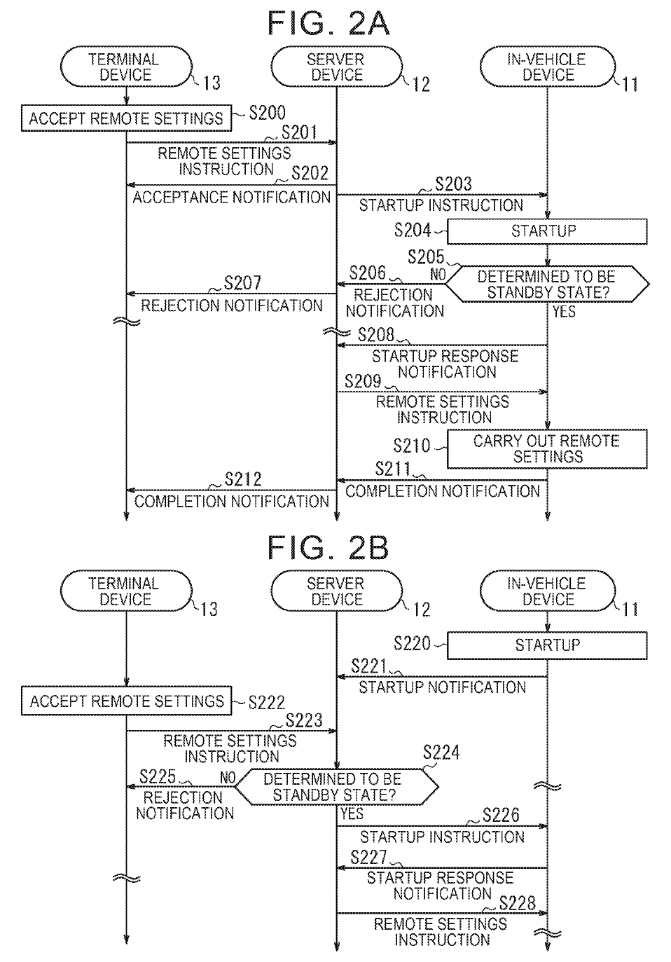

The operations of the control system 1 according to the present disclosure will be described with reference to FIGS. 2A and 2B. In the following, the operations of the in-vehicle device 11 are performed by the control unit 113, and data communication is performed via the communication unit 111. User operations on the in-vehicle device 11 are accepted via the input unit 114. In the same way, the operations of the server device 12 are performed by the control unit 123, and data communication is performed via the communication unit 121.

FIG. 2A shows an example of operation procedures of the control system 1 according to a first embodiment.

In S200, the terminal device 13 accepts remote settings for operations of vehicle 10 from the user. In S201, the terminal device 13 sends a remote settings instruction to the server device 12.

In S202, the server device 12 sends a notification to the terminal device 13 that the remote settings instruction has been accepted. This enables the user to confirm the status of the remote settings. In S203, the server device 12 sends, to the in-vehicle device 11, a signal instructing the in-vehicle device 11 to perform startup and transition to the running state (hereinafter referred to as "startup instruction"). When the in-vehicle device 11 is in the standby state, startup of the in-vehicle device 11 is performed up in response to receiving the startup instruction, and thus transitions to the running state in step S204. When the in-vehicle device 11 is in the running state in S204, the flow advances to step S205 without responding to the startup instruction.

When determination is made in S205 that the in-vehicle device 11 was in the running state (i.e., not in the standby state) when the startup instruction was received (No in step S205), in step S206 a notification rejecting the remote settings instruction (hereinafter referred to as "rejection notification") is sent to the server device 12. That is to say, the in-vehicle device 11 does not perform remote settings while in the running state. In S207, the server device 12 sends the rejection notification to the terminal device 13. On the other hand, in the running state, the in-vehicle device 11 accepts user operations for direct settings on the in-vehicle device 11 and performs the direct settings. In this way, when the in-vehicle device 11 is in the running state, control conflict can be circumvented by rejecting remote settings instructions via the server device 12 and not performing remote settings, but instead performing direct settings in accordance with operations made on the in-vehicle device 11.

In S205, when determining that the state was the standby state when receiving the startup instruction (Yes in step S205), in step S208 the control unit 113 sends, to the server device 12, a notification indicating having transitioned to the running state in response to the startup instruction (hereinafter referred to as "startup response notification"), or a request for a remote settings instruction (hereinafter referred to as "instruction request"). In S209, the server device 12 sends the remote settings instruction to the in-vehicle device 11. In S210, the in-vehicle device 11 carries out the remote settings in response to the remote settings instruction. In this way, the in-vehicle device 11 can transition from the standby state to the running state in response to a startup instruction, and perform remote settings via the server device 12. In S211, upon completing the remote settings, the in-vehicle device 11 sends a completion notification to the server device 12. In S212, the server device 12 sends the completion notification to the terminal device 13. At this time, the in-vehicle device 11 may transition from the running state to the standby state in response to the completion of step S210, or by receiving a stop instruction via the server device 12 from the user who has confirmed the completion notification.

FIG. 2B shows an example of operation procedures of the control system 1 according to a second embodiment.

In S220, startup of the in-vehicle device 11 is performed in the standby state and is transitioned to the running state, by the user directly operating the in-vehicle device 11, or by remotely operating the in-vehicle device via the server device 12. In S221, upon transitioning to the running state, the in-vehicle device 11 sends a startup notification to the server device 12.

The processing of S222 and 223 is equivalent to that of steps S200 and 201. Here, the processing of steps S220 and 221, and steps S222 and 223, may be carried out concurrently, with steps S222 and 223 being carried out first, or being carried out alternately. Also, steps S220 and 221 may be omitted.

In S224, upon receiving the remote settings instruction from the terminal device 13, the server device 12 determines whether the in-vehicle device 11 is in the standby state. The server device 12 determines that the in-vehicle device 11 is in the running state (i.e., not in standby state) on the condition of having received the startup notification. At this time, the server device 12 associates the startup notification with the in-vehicle device 11 by an optional method. For example, the server device 12 can set a flag indicating that the in-vehicle device 11 is in the running state, which flag corresponds to the startup notification. Upon determining that the in-vehicle device 11 is in the running state (No in step S224), the server device 12 sends a rejection notification to the terminal device 13 in step S225. That is to say, the server device 12 stops sending the remote settings instruction to the in-vehicle device 11. Note that the in-vehicle device 11 accepts a direct settings operation, and performs direct settings in the running state. Also, before transitioning from the running state to the standby state, the in-vehicle device 11 sends, to the server device 12, a notification to cancel the startup notification or a notification to transition to the standby state. Upon receiving this notification, the server device 12 cancels the reception of the startup notification in step S221.

Upon determining in S224 that the in-vehicle device 11 is in the standby state (Yes in step S224), the server device 12 sends a startup instruction to the in-vehicle device 11 in step S226. In S227, the in-vehicle device 11 sends a startup response notification or an instruction request to the server device 12. In S228, the server device 12 sends a remote settings instruction to the in-vehicle device 11. Next, the flow transitions to steps equivalent to step S210 and subsequent steps in FIG. 2A.

As a modification of S224, even when determining that the in-vehicle device 11 is in the running state, the server device 12 may send a remote settings instruction to the in-vehicle device 11 within a predetermined period after having received the startup notification. The predetermined period may be any period of time, such as a few milliseconds to a few seconds, or the like . This enables the in-vehicle device 11 to carry out the remote settings sent by the terminal device 13 at a timing such as until the startup notification reaches the server device 12, until the server device 12 performs processing of the startup notification, or the like.

Note that in the first embodiment and the second embodiment, the in-vehicle device 11 may invalidate direct settings by operating the in-vehicle device 11, from the time of receiving a remote settings instruction from the server device 12 until performing the remote settings, or until a predetermined period of time elapses from having received the remote settings instruction. Alternatively, the server device 12 may send such an invalidation instruction to the in-vehicle device 11, along with the remote settings instruction. This predetermined period is an optional amount of time, such as for example, 1 to 3 minutes, or the like. Also, in order to invalidate direct settings, the in-vehicle device 11 may invalidate the input unit 114, or may cause the output unit 115 to perform output that direct settings will not be accepted. This enables further improvement of the accuracy of the settings.

Also, in the first embodiment and the second embodiment, upon receiving a plurality of remote settings instructions between sending a startup instruction while the in-vehicle device 11 is in the standby state and receiving a startup response notification or instruction request, the server device 12 may determine whether object operations of the remote settings instructions (e.g., air conditioning temperature settings) overlap. When determining that there is overlapping, the server device 12 may send only the most recent remote settings instruction to the in-vehicle device 11, based on a timestamp or the like at the point in time when the server device 12 or the terminal device 13 received the remote setting instruction. Alternatively, when the in-vehicle device 11 receives a plurality of the remote settings instructions, this determination may be made by the in-vehicle device 11. This allows for a certain amount of time to be taken for the in-vehicle device 11 to transition to the running state after receiving the startup instruction, and accordingly enables further improvement of the accuracy of settings in which object operations overlap.

As a modification of the first embodiment and the second embodiment, the present disclosure may be applied only to a case in which settings are made such that, among the operations of the vehicle 10, operations of the drive recorder are the object.

Although the present disclosure has been described above based on the drawings and the embodiment, it should be noted that those skilled in the art may make various modifications and alterations thereto based on the present disclosure. It should be noted, therefore, that these modifications and alterations are within the scope of the present disclosure. For example, the functions and so forth included in the configurations, the steps, and so forth, can be rearranged such that no logical inconsistency arises, and a plurality of the configurations, the steps, and so forth, can be combined into one or divided.

Also, an embodiment may be made in which a general-purpose computer, for example, functions as the in-vehicle device 11 or the server device 12 according to the above embodiment. Specifically, a program, in which are described processing contents for realizing the functions of the in-vehicle device 11 or the server device 12 according to the above-described embodiment, is stored in memory of a general-purpose computer, and the program is read out and executed by a processor. Accordingly, the present disclosure can also be realized as a program that can be executed by the processor or a non-transitory computer-readable medium that stores the program.

What is claimed is:

1. An in-vehicle device for performing setting of operations of a vehicle, the in-vehicle device comprising:
a communication unit that communicates with a server device;
an input unit that accepts an operation of a user; and
a control unit that transitions the in-vehicle device from a standby state to a running state in which a first setting is performed by an operation by the user, in response to a startup instruction, and after transitioning to the running state, does not perform a second setting by an instruction from the server device.

2. The in-vehicle device according to claim 1, wherein, upon receiving the startup instruction from the server device in the standby state, the control unit performs the second setting even after transitioning to the running state.

3. The in-vehicle device according to claim 1, wherein the control unit performs the second setting on a condition of receiving an instruction for the second setting that is sent from the server device, within a predetermined period of time after receiving a notification from the server device indicating transitioning to the running state.

4. The in-vehicle device according to claim 3, wherein the control unit invalidates the input unit from when the instruction for the second setting is received, until the second setting is performed.

5. A server device, comprising:
a communication unit that communicates with an in-vehicle device that performs setting of operations of a vehicle; and
a control unit that sends an instruction to the in-vehicle device to perform the setting when the in-vehicle device is in a standby state, wherein
upon receiving a notification from the in-vehicle device indicating that the in-vehicle device transitioned to a running state, the control unit cancels sending the instruction to the in-vehicle device.
